(19) United States
(12) Patent Application Publication
(10) Pub. No.: US 2008/0250458 A1
(43) Pub. Date: Oct. 9, 2008

(54) Media exchange for handheld wireless receivers and other media user devices

(76) Inventor: Kendyl A. Roman, Sunnyvale, CA (US)

Correspondence Address: KENDYL A ROMAN, 730 BARTEY COURT, SUNNYVALE, CA, 94087, US

(21) Appl. No.: 12/157,225

(22) Filed: Jun. 7, 2008

Related U.S. Application Data
(63) Continuation-in-part of application No. 10/154,775, filed on May 24, 2002.
Application No. 10/154,775 is a continuation-in-part of application No. 11/262,106, filed on Oct. 27, 2005.
Application No. 11/262,106 is a continuation-in-part of application No. 09/467,721, filed on Dec. 20, 1999, now Pat. No. 7,233,619.
(60) Provisional application No. 60/293,772, filed on May 26, 2001.
(60) Provisional application No. 60/113,051, filed on Dec. 21, 1998.

(51) Int. Cl. G06F 13/00; H04N 7/173

(52) U.S. Cl. 725/61; 725/87

(57) ABSTRACT

A system and methods of providing a globally accessible media exchange, whereby media creators, media rights holders, and agents can offer media and media rights to a world-wide market. Media users and publishers can find and preview the media that they need or want and purchase media ownership or license media rights through the media exchange. The media exchange can store digital graphics, audio, and video. The media exchange can also manage the transfer of media and media rights for physical media. In some embodiments, the media exchange can establish a dynamic fair market value based on matching asking prices and bids. Some embodiments could be limited to a single media type such as just audio media. A handheld, wireless video receiver that receives compressed video, decompresses the compressed video, displays the decompressed video. The receiver is part of a system comprising methods, medium, and handheld, wireless devices that compress, transmit, decompress and display digital video images. Real time wireless videoconferences connect multiple handheld video devices. The receiver can alter various setting including but not limited to the format for the compression, image size, frame rate, brightness and contrast. A zoom control can be used select a portion of interest of video being transmitted or being played back. The receiver may also have a touch sensitive display screen providing controls for video display and mobile telephone operation.

### CROSS-REFERENCE TO RELATED APPLICATIONS

This application is also a continuation in part of U.S. patent application Ser. No. 10/154,775, filed on May 24, 2002, published as US 2003/0005428, and entitled “GLOBAL MEDIA EXCHANGE,” which is hereby incorporated by reference.

U.S. patent application Ser. No. 10/154,775 claims priority under 35 U.S.C. § 199(e) of the U.S. provisional application Ser. No. 60/293,772, filed 2001 May 26, entitled “GLOBAL MEDIA ARCHIVE,” which is also hereby incorporated by reference.

This application is also a continuation in part of co-pending U.S. patent application Ser. No. 11/262,106, filed on Oct. 27, 2005, published Jun. 1, 2006, as U.S. patent application publication 2006/0114987, entitled “HANDHELD VIDEO TRANSMISSION AND DISPLAY,” which hereby is incorporated by reference.

U.S. patent application Ser. No. 11/262,106 is a continuation in part of U.S. patent application Ser. No. 09/467,721, filed on Dec. 20, 1999, and entitled “VARIABLE GENERAL PURPOSE COMPRESSION FOR VIDEO IMAGES (ZLN)”, now U.S. Pat. No. 7,233,619, which hereby is incorporated by reference.

This application and application Ser. No. 09/467,721 claim priority under 35 U.S.C. § 119(e) of U.S. provisional application Ser. No. 60/113,051, filed on Dec. 21, 1998, and entitled “METHODS OF ZERO LOSS (ZL) COMPRESSION AND ENCODING OF GRAYSCALE IMAGES”, which hereby is incorporated by reference.

My U.S. patent application Ser. No. 09/312,922, filed on May 17, 1999, and entitled “SYSTEM FOR TRANSMITTING VIDEO IMAGES OVER A COMPUTER NETWORK TO A REMOTE RECEIVER,” now U.S. patent Ser. No 7,257,158, is also hereby incorporated by reference.

My U.S. patent application Ser. No. 09/433,978, now U.S. Pat. No. 6,803,931, filed on Nov. 4, 1999, and entitled GRAPHICAL USER INTERFACE INCLUDING ZOOM CONTROL REPRESENTING IMAGE AND MAGNIFICATION OF DISPLAYED IMAGE”, is also hereby incorporated by reference. A co-pending divisional application of U.S. Pat. No. 6,803,931, is U.S. patent application Ser. No. 10/890,079, filed on Jul. 13, 2004, published on Dec. 9, 2004 as publication number 2004/0250216, and entitled GRAPHICAL USER INTERFACE INCLUDING ZOOM CONTROL REPRESENTING IMAGE AND MAGNIFICATION OF DISPLAYED IMAGE”, and is also hereby incorporated by reference.

My U.S. patent application Ser. No. 09/470,566, now U.S. Pat. No. 7,016,417, filed on Dec. 22, 1999, and entitled GENERAL PURPOSE COMPRESSION FOR VIDEO IMAGES (RHN)”, describes a compression method known as the “RHN” method, and is also hereby incorporated by reference.

My co-pending U.S. patent application Ser. No. 09/473,190, filed on Dec. 20, 1999, and entitled “ADDING DOPPLER ENHANCEMENT TO GRAYSCALE COMPRESSION (ZLD)” is also hereby incorporated by reference.

U.S. patent application Ser. No. 09/436,432, filed on Nov. 8, 1999, and entitled “SYSTEM FOR TRANSMITTING VIDEO IMAGES OVER A COMPUTER NETWORK TO A REMOTE RECEIVER,” now U.S. Pat. No. 7,191,462, is wholly owned by the inventor of the present invention.

### BACKGROUND

1. Field of the Invention

This invention relates to media exchange, specifically to use of a computer based media archive and electronic market (or store) for exchanging media rights and copies of the media based on those rights. This invention also relates to handheld devices for video and audio transmission, including video capture, wired and wireless file transfer and live streaming, and display.

2. Description of Prior Art

### Physical Media

Though out time, man has created and recorded images and sounds in various media. These images and sounds add value to the media because they communicate either information or aesthetic beauty. Examples of physical media include cave wall hieroglyphics, stone tablets, metal plates, papyrus scrolls, parchment, ink on paper, paint on canvas, photographic film, printed photographs, motion picture film, phonograph records, audio tapes, compact diskettes, video tapes, DVDs, sculptures, and other pieces of fine art.

Because the ideas and expressions contained on physical media have value, people and governments have provided protection of the content of the media through patents, copyrights, and tradesecret rights.

### Digital Media

With the development of computers and related technology the informational and aesthetic content of physical medical can be captured and stored in electronically readable digital format. The physical characteristics of color, light and sound are measured and the measurements are stored as numbers. The numbers that represent the physical characteristics of the content (ideas and expression) are stored electronically in digital media. Examples of digital media are files stored on a computer hard disk, CD-ROM, DVD, magnetic tape, floppy diskette; data stored in a computer memory; or data being transferred over a computer network.

Content can be created directly in digital form. For example, digital artists can create images using computers to draw or calculate components of the image. Engineers and architects use computers to create drawings, schematics, and blue prints. Movies and music can also be created using computers or other electronics.

### Media Conversion

Regardless of whether media content is created in a physical or digital form, all media can be represented in a digital form. Physical media can be converted into digital media and still contain the essence of the ideas or expression. For example, a photograph, painting, or blueprint, can be scanned and converted into a digital form. A sound recording can be digitized for storage in a digital form.

Any media content in digital form can be converted into a physical form. For example, a digital photograph or digital blueprint can be printing on paper. An audio digital compact disk can be transferred to regular audio tape. Even a digital representation of a sculpture can be recreated physically using robots, milling machines, or lasers.

### Media Distribution and Marketing Overhead

Traditionally for media to be transferred from media creators to media users it must move through a thick layer of agents, brokers, marketing organizations, distribution channels, middlemen, wholesalers, and retail stores. Each entity along the route adds overhead and takes its piece of the purchase price. For example, a recording artist may only receive a few pennies for every fourteen dollar ($14.00) compact diskette sold after agents, record label, distribution channels, wholesalers, and retailers have all taken a portion of the amount received from the media user.

A system that gives the media creator higher fees while reduced the cost to media users is needed.

### Media Databases

Fundamentally a database is a collection data with a system for managing or accessing the data. Various types of databases are known including hierarchical, network, relational, object oriented, and flat file databases. In recent years relational database have become popular. Examples of relational databases are System R, Ingres, Oracle, Sybase, Progress, Informix, Databean and Pointbase.

A number of database systems have the ability to store large data objects such as digital media and can be referred to as a media database. A combination of a regular file system and any database that references digital media files by file name or other location information can also be used to create a media database. Some media databases can automatically analyze the content of the digital media to create search index information. For example, a picture of an African American officer worker could be analyzed and automatically tagged with the following key words: “woman”, “red dress”, “black”, “African American”, “phone”, “desk”, “computer monitor”, and “books”.

A number of media database have been built, but access is limited. It is very hard for a media user to find the media that they need at a reasonable price. A system is needed to give media creators and media users world-wide access to media.

### Media Rights

Because media together with its content has value, its owners have certain rights. The rights to copy, display, perform, or modify an expression is owned by the creators of the media. The rights to make, use, or sell any media that use a patented idea is granted to the inventor. Information that is kept secret and which has economic value by not being disclosed is protected by tradesecret rights. The ownership of these rights can be transferred to others by selling or licensing the rights. Typically when rights are licensed the owner receives a reasonable royalty for exercise of the rights.

Fundamentally the creator of media retains the rights. However, the rights may be assigned to another by transferring ownership to another person or company who becomes the media rights holder. The media rights holder can license the media rights to others who want use the media, the media users.

### Infringement of Rights

As technology advances, it is easier and easier to copy media that is protected by media owners rights. For example, the copy machine has made it easier to copy printed text and drawings. The color copier has made it possible to copy color photographs. Today the typical home computer can copy music and videos in digital form. With new analysis tools, equipment, and computer programs, media containing tradesecrets and patented ideas can easily be disassembled, scanned, and reverse engineered.

Because of the ease of piracy and theft of protected media, owners of media rights are forced to limit the distribution of their media and to charge higher license royalties to the honest users of their rights.

What is needed is a system that allows media rights holders to make their media available to the broadest possible audience in such a way that they are easily compensated for the use of their media. Such a system would increase the number of people using the media and would increase the compensations to the media rights holders. When the media rights holder is fairly compensated for the use of the media by a larger number of media users, the average cost of the license can go down. When the cost of each license is low and the license fee is easily negotiated, paid and collected, their incentive to pirate media is diminished.

### Project XANADU

For over 40 years, Ted Nelson has been trying to establish a system where copyright holders are properly acknowledged and compensated. The project known as Project XANADU has been fighting, and continues to fight, for a world of deep electronic documents—with side-by-side intercomparison and frictionless re-use of copyrighted material.

The decades old project tries to do too much in a way that has not been successful and has failed to produce the needed result.

### Internet

For over 30 years, the Internet has provide a medium for transmitting digital data. The Internet is a world-wide interconnected system of computers and computer networks. The Internet made digital media more easily accessible but by itself has only increased the problem of media piracy. By itself, the Internet has increased the problem rather than solving the problem of fair compensation to media rights holders.

### World Wide Web

The World Wide Web, shortened as Web, is an information space within the Internet. Inspired by Ted Nelson's hypertext concept, the Web provides a uniform way to access certain media on the Internet. Web browsers combined with Web search engines and media sharing programs have made it easier for media users to find and take copies of media. The Web by itself has only increased the problem of media piracy. By itself, the Web has increased the problem rather than solving the problem of fair compensation to media rights holders.

### Stock Market

A stock market such as the New York Stock Exchange or the NASDAQ provides a model for buyers and sellers to dynamically create a fair market price for a stock. Buyers and sellers through out the world can obtain the current stock price, offer to sell stock they own, or make a bid to buy stock at a certain price. At any moment in time a fair market price is determined by matching the highest bid with the lowest offer. Stock brokers can act as agents of stock buyers and sellers. Stock buyers and seller can trade directly with each other through an online stock trading system.

### The Problems Remains

Despite the advances in database technology, Internet connectivity, and Web access to media, several problems remain. Media creators and media rights holders need a much larger, world-wide, market for what they have. However in giving media rights holders a larger market, their rights to fair compensation for use of their media must be protected an enhanced. Media piracy must been reduced before license fees can be reduced. Media users throughout the world need access to the media that is available, they need to be able to quickly search for what they want, and then they need to easily pay the license fees and easily and quickly obtain access to the media. Media users need and want lower license fees. Overhead in the path between media creators and media users needs to be eliminated to further increase the amounts received by media creators and further decrease the amounts paid by media users. All of these problems can be solved with the present invention.

### Compression

In the last few years, there have been tremendous advances in the speed of computer processors and in the availability of bandwidth of worldwide computer networks such as the Internet. These advances have led to a point where businesses and households now commonly have both the computing power and network connectivity necessary to have point-to-point digital communications of audio, rich graphical images, and video. However the transmission of video signals with the full resolution and quality of television is still out of reach. In order to achieve an acceptable level of video quality, the video signal must be compressed significantly without losing either spatial or temporal quality.

A number of different approaches have been taken but each has resulted in less than acceptable results. These approaches and their disadvantages are disclosed by Mark Nelson in a book entitled The Data Compression Book, Second Edition, published by M&T Book in 1996. Mark Morrision also discusses the state of the art in a book entitled The Magic of Image Processing, published by Sams Publishing in 1993.

### Video Signals

Standard video signals are analog in nature. In the United States, television signals contain 525 scan lines of which 480 lines are visible on most televisions. The video signal represents a continuous stream of still images, also known as frames, that are fully scanned, transmitted and displayed at a rate of 30 frames per second. This frame rate is considered full motion.

A television screen has a 4:3 aspect ratio.

When an analog video signal is digitized each of the 480 lines is sampled 640 times, and each sample is represented by a number. Each sample point is called a picture element, or pixel. A two dimensional array is created that is 640 pixels wide and 480 pixels high. This 640×480 pixel array is a still graphical image that is considered to be full frame. The human eye can perceive 16.7 thousand colors. A pixel value comprised of 24 bits can represent each perceivable color. A graphical image made up of 24-bit pixels is considered to be full color. A single, second-long, full frame, full color video requires over 220 millions bits of data.

The transmission of 640×480 pixels×24 bits per pixel times 30 frames requires the transmission of 221,184,000 million bits per second. A T1 Internet connection can transfer up to 1.54 million bits per second. A high-speed (56 Kb) modem can transfer data at a maximum rate of 56 thousand bits per second. The transfer of full motion, full frame, full color digital video over a T1 Internet connection, or 56 Kb modem, will require an effective data compression of over 144:1, or 3949:1, respectively.

A video signal typically will contain some signal noise. In the case where the image is generated based on sampled data, such as an ultrasound machine, there is often noise and artificial spikes in the signal. A video signal recorded on magnetic tape may have fluctuations due the irregularities in the recording media. Florescent or improper lighting may cause a solid background to flicker or appear grainy. Such noise exists in the real world but may reduce the quality of the perceived image and lower the compression ratio that could be achieved by conventional methods.

### Portable Hand Held Devices: Pen-Based Computers and PDAs

In the early 1990s, a number of pen based computers were developed. These portable computers were characterized by a display screen that could be also used as an input device when touched or stroked with a pen or finger. For example in 1991, NCR developed a “notepad” computer, the NCR 3125. Early pen-based computers ran three operating systems: DOS, Microsoft's Windows for Pen Computing and Go Corp.'s PenPoint. In 1993, Apple developed the Newton MessagePad, an early personal digital assistant (PDA). Palm developed the Palm Pilot in 1996. Later, in 2002, Handspring released the Treo which runs the Palm OS and features a Qwerty keyboard. In 2000, the Sony Clie, used the Palm OS and could play audio files. Later versions included a built-in camera and could capture and play Apple QuickTime™ video. Compaq (now Hewlett Packard) developed the iPAQ in 2000. The iPAQ and other PocketPCs run a version of Windows CE. Some PocketPC and PDA have wireless communication capabilities.

In 2001, Apple released a music player, called the iPod, featuring a small, internal hard disk drive that could hold over 1000 songs and fit in your pocket. The original iPod has a display, a set of controls, and ports for connecting to a computer, such as a Macintosh or PC, via Firewire, and for connecting to headphones. However, the original iPod did not have a color display, a built-in camera, built-in speakers, built-in microphone or wireless communications.

### Portable Hand Held Devices: Cell Phone and Picture Phones

The first cellular telephones had simple LCD displays suitable for displaying only a limited amount of text. More recently, cell phones have been developed which have larger, higher resolution displays that are both grayscale and color. Some cell phones have been equipped with built-in cameras with the ability to save JPEG still photos to internal memory. In April 2002, Samsung introduced a cell phone with a built-in still photo camera and a color display. The Samsung SCH-X590 can store up to 100 photos in its memory and can transfer still photos wirelessly.

Cell phones can be used as wireless modems. Initially they had limited data bandwidth. Next, digital cell phones were developed. By early 2002, bandwidth was typically 60-70 Kbps. Higher bandwidth wireless networks are being developed.

### Hand Held Devices are Limited is Size and Weight

Hand held devices are limited in size and weight. Many users are only willing to use a handheld device that weights a few ounces and can fit inside a typical shirt pocket, or even worn on their waist or arm. These size and weight limitation prevent handheld devices from having the electronic circuitry, processors, and batteries found in laptops and other larger computers. These limitations have made it impossible to provide full frame, full motion video display or live transmission on handheld devices.

### PDAs, PocketPCs, and Picture Phones are Limited by Battery Life, Processor Speed, and Network Bandwidth

The existing, commercially available hand held devices have not been able to support live or streaming video for a number of reasons. Uncompressed full-motion, full frame video requires extremely high bandwidth that is not available to handheld portable devices. In order to reduce the bandwidth, lossy compression such as MPEG has been used to reduce the size of the video stream. While MPEG is effective in desktop computers with broadband connections to the Internet, decoding and displaying MPEG encoded video is very processor intensive. The processors of existing handheld devices are slower or less powerful than those used in desktop computers. If MPEG were used in a handheld device, the processor would quickly drains the battery of most handheld devices. Further, the higher bandwidth wireless communications interfaces would also place a large strain on the already strained batteries. Live video transmission and reception would be even more challenging. For this reason, handheld device have not been able to transmit or receive streaming, or especially, live video.

What is needed is an enhanced handheld device that is capable of receiving streaming and live video. Further a handheld device that could capture and transmit live video would provide live coverage of events that would otherwise not be able to be seen. With handheld video devices that both transmit and receive live video, handheld wireless videoconferencing could become a reality. Also a video compression method that requires significantly reduced processing power and would be less draining on the battery of a handheld device is needed. Additionally since, handheld video display screens which are smaller than typical computer screens, a user of a handheld video receiver needs to be able control the portion of a video be transmitted to allow a smaller, higher quality video to be received and viewed on the handheld screen with dimensions smaller than the original video.

### SUMMARY OF THE INVENTION

The present invention combines database, Internet, and Web technology with the concepts of the stock market to create a world wide, globally accessible, media exchange wherein media users compensate media rights holders for use of media, and wherein media rights holders are given access to a world wide market of media users. The system and methods of the present invention are known as a “Global Media Exchange.” Additionally the present invention can be used to create a dynamic fair market price for any media or type of media rights licensing. Additionally, through the use of accounts within the system or through external accounts, such as bank or credit card accounts, media buyers and sellers can easily and automatically purchase and sell rights, and send or receive payments. Alternatively, the exchange can be compensated for providing services including but not limited to storing and hosting, accounting, transaction processing, reporting, printing, copying, receiving, shipping, and tracking for media exchanges.

The present invention also teaches that, in some cases, media creators, media rights holders, and media users may interact with the system through agents or brokers. Some media users may be publishers who obtain the right to use media in publications that each publisher distributes to one or more publication users.

The present invention can store digital media in its media archive. It can also store references to physical media in its database so that prices can be determined and originals and copies can be exchanged.

The present invention also provides a method for ordering physical copies of digital media.

In accordance with the present invention a handheld device comprises a black and white or color video display screen, speakers or headphones for hearing audio associated with the video display, controls for user input, a memory for storing compressed video data, and a processor for running computer programs which decompress the compressed video data and play the video on the display screen, and the video's audio on speakers and/or headphones. Further, some embodiments of the present invention include a microphone and video camera for inputting audio and video. A plurality of handheld video devices are connected to a network for exchanging video file, streaming video from a pre-recorded video file or live transmission from one device to one or more devices in remote locations. The network connections can be wired or wireless.

One embodiment of the present invention comprises a video camera that can be removably mounted on an iPod-type device to add the video capture capability. Further the separate camera unit could include a microphone or speakers. Further, wireless communications could be added to the separate camera unit or as yet another removable unit.

Further, the present invention includes a method of compression of a video stream comprising steps of sub-sampling a video frame, and run-length encoding the sub-sampled pixel values, whereby the method can be executed in real time, and whereby the compressed representation of pixels saves substantial space on a storage medium and requires substantially less time and bandwidth to be transported over a communications link. The present invention includes a corresponding method for decompressing the encoded data.

Further, the present invention includes a zoom control that is graphically displayed on the display screen and receives input from either the touch screen or the controls of the handheld device. A user may use the zoom control to send remote control commands to a transmitting device to dynamically specify an area to be transmitted. Alternatively, the user may use the zoom control to magnify video that is being played from a file.

### OBJECTS AND ADVANTAGES

Accordingly, beside the objects and advantages of the method described above, some additional objects and advantages of the present invention are:
(a) To provide a computer based exchange for media rights.
(b) To provide a global, world-wide market for selling media.
(c) To provide a global, world-wide market for licensing media rights.
(d) To provide a global, world-wide archive for digital media.
(e) To increase the volume and types of media available to media users.
(f) To provide a system for determining global fair market values for media and various media rights.
(g) To increase the compensation to media creators and media rights holders.
(h) To decrease the cost associated with using media.
(i) To reduce the overhead in transferring media from media creators to media users.
(j) To reduce the size of stored digital media.
(k) To reduce the bandwidth required to transmit stored digital media.
(l) To provide a system for ordering physical copies of digital media.
(m) To provide a system for tracking the transfer of original physical media and physical copies of digital media to media users.
(n) To provide a reliable, easy to use storage facility for digital media.
(o) To provide an international currency exchange for media rights transactions.
(p) To provide a means for publishing a variety of media types.
(q) To provide a secure means for sharing media with select media users.
(r) To provide a means of maintaining a record of media ownership, namely a title chain.
(s) To provide a handheld device for capturing audio and video which can be transmitted to another video display device.
(t) to provide a handheld device for displaying video that has been received from a video capture and transmission device.
(u) To provide a handheld wireless video conferencing system comprising handheld devices which act as both transmitters and receivers connected over a data network.
(v) To provide an add-on module that will allow an iPod-type device to capture, transmit, or receive video.
(w) To provide a graphical zoom control on a hand held video display device whereby the user can remotely control the area of the video that is being transmitted in high resolution.
(x) To provide a graphical zoom control on a hand held video display device whereby the user can magnify a video being displayed.
(y) To provide a method of compressing and decompressing video signals so that the video information can be transported across a digital communications channel in real time.
(z) To provide a method of compressing and decompressing video signals such that compression can be accomplished with software on commercially available computers without the need for additional hardware for either compression or decompression.
(aa) To provide a high quality video image without the blocking and smearing defects associated with prior art lossy methods.
(bb) To provide a high quality video image that suitable for use in medical applications.
(cc) To enhance images by filtering noise or recording artifacts.
(dd) To provide a method of compression of video signals such that the compressed representation of the video signals is substantially reduced in size for storage on a storage medium.
(ee) To provide a level of encryption so that images are not directly viewable from the data as contained in the transmission.

### DRAWING FIGURES

In the drawings, closely related figures have the same number but different alphabetic suffixes.

FIG. 1A shows an example of a media exchange.

FIG. 1B shows the flow of media through a media exchange.

FIG. 2A shows a flow chart of the method of adding media to an exchange.

FIG. 2B shows a flow chart of the method of retrieving media from a media exchange.

FIG. 3 shows an image and a corresponding stream of pixels.

FIGS. 4A and 4B show machines for compressing and decompressing, respectively.

FIG. 4C shows a compressor and decompressor connected to a storage medium.

FIG. 4D shows a compressor and decompressor connected to a communications channel.

FIGS. 5A through 5C show various network configuration comprising handheld video devices.

FIGS. 6A through 6D show various embodiments of handheld video devices.

FIGS. 7A through 7C show handheld video devices comprising graphical zoom controls.

Reference Numerals in Drawings

| | |
|---|---|
| 102 | media exchange |
| 104 | use by media creator |
| 106 | media rights holder |
| 108 | media submission |
| 110 | media creator |
| 111 | delegation |
| 112 | agent |
| 114 | indirect submission |
| 116 | individual use |
| 118 | publication use |
| 120 | media user |
| 122 | publisher |
| 124 | published use |
| 126 | another published use |
| 128 | publication user |
| 130 | another publication user |
| 132 | media archive |
| 134 | graphic media |
| 136 | graphic submission |
| 138 | audio media |
| 140 | audio submission |
| 142 | video media |
| 144 | video submission |
| 146 | physical media |
| 148 | physical description |
| 150 | transfer to shipper |
| 152 | shipper |
| 154 | physical delivery |
| 156 | system user |
| 158 | user interface |
| 160 | user's computer |
| 162 | archive interface |
| 164 | rights delivery |
| 166 | duplication order |
| 168 | duplicator |
| 170 | copy creation |
| 200 | submission start |
| 202 | path 202 |
| 204 | create media step |
| 206 | path 206 |
| 208 | physical decision |
| 210 | describe step |
| 212 | physical path 212 |
| 214 | upload and describe step |
| 216 | digital path 216 |
| 218 | set license terms step |
| 220 | path 220 |
| 222 | path 222 |
| 224 | path 224 |
| 226 | submission finish |
| 228 | retrieval start |
| 230 | path 230 |
| 232 | search archive step |
| 234 | path 234 |
| 236 | select item step |
| 238 | path 238 |
| 240 | more decision |
| 242 | more path |
| 244 | no more path |
| 246 | pay fees step |
| 248 | path 248 |
| 250 | receive items step |
| 252 | path 252 |
| 254 | retrieval finish |
| 430 | image |
| 440 | image width |
| 450 | image height |
| 460 | pixel stream |
| 1200 | video frames |
| 1210 | compressor |
| 1215 | video signal |
| 1220 | series of encoded data |
| 1225 a | first encoded data |
| 1225 b | second encoded data |
| 1225 n | nth encoded data |
| 1225 | encoded data buffer |
| 1230 a | first received encoded data |
| 1230 b | second received encoded data |
| 1230 n | nth received encoded data |
| 1230 | received encoded data |
| 1235 | encoded data stream |
| 1238 | received encoded data |
| 1240 | I/O device |
| 1245 | input encoded data stream |
| 1250 | decompressor |
| 1260 a | first decoded video frame |
| 1260 b | second decoded video frame |
| 1260 n | nth decoded video frame |
| 1260 | decoded video frame |
| 1268 | decoded video frames |
| 1270 | video sequence |
| 1280 | storage medium |
| 1290 | communications channel |
| 1910 | network |
| 1930 | reflector |
| 1940 | point-to-point transmission |
| 1942 | first indirect path |
| 1944 | second indirect path |
| 2010 | first handheld device |
| 2012 | display |
| 2014 | controls |
| 2016 | wireless port |
| 2020 | headphone |
| 2021 | right speaker |
| 2022 | microphone |
| 2023 | left speaker |
| 2024 | speaker/microphone cable |
| 2030 | camera |
| 2032 | lens |
| 2034 | camera cable |
| 2040 | second handheld device |
| 2050 | wireless connection |
| 2051 | wired connection |
| 2052 | video source |
| 2054 | video transmitter |
| 2056 | video storage |
| 2060 | integrated handheld device |
| 2062 | A/V module |
| 2064 | wireless module |
| 2070 | cellular integrated device |
| 2100 | zoom control |
| 1205 a | first video frame |
| 1205 b | second video frame |
| 1205 n | nth video frame |
| 1901 a | first video |
| 1901 b | first reflected video |
| 1902 a | second video |
| 1902 b | second reflected video |
| 1910 a | wired network |
| 1910 b | wireless network |
| 1910 c | combined network |
| 1920 a | first node |
| 1920 b | second node |
| 1920 c | third node |
| 1920 d | fourth node |
| 1920 e | fifth node |
| 2012 b | second display |
| 2012 d | phone display |
| 2014 d | phone controls |
| 2016 b | second wireless port |
| 2016 c | integrated wireless port |
| 2016 d | cellular port |
| 2021 b | right built-in speaker |
| 2021 c | right integrated speaker |
| 2021 d | right phone speaker |
| 2021 e | phone earphone |
| 2022 b | built-in microphone |
| 2022 c | integrated microphone |
| 2022 d | phone microphone |
| 2023 b | left built-in speaker |
| 2023 c | left integrated speaker |
| 2023 d | left phone speaker |
| 2030 b | built-in camera |
| 2030 c | integrated camera |
| 2030 d | phone camera |
| 2051 a | first wired connection |
| 2051 b | second wired connection |
| 2102 a | inner region |
| 2102 b | second inner region |
| 2102 c | third inner region |
| 2104 a | magnification factor |
| 2104 b | second magnification factor |
| 2104 c | third magnification factor |
| 2106 a | outer region |
| 2106 b | second outer region |
| 2106 c | third outer region |
| 2110 a | video display window |
| 2110 b | alternate video display window |

### SPECIAL DEFINITIONS

media—plural of medium, media as used herein broadly refers to a) an intervening substance through which something is transmitted or carried on, b) material or technical means of expression as determined by the materials or creative methods involved, or c) the content of (a) or (b) comprising ideas or expressions that may have associated copyright, patent, or trade secret rights.

media creator—a person or legal entity that discovers and idea or creates an expression there by derives media rights.

media rights holder—a media creator or person or legal entity assigned rights originally held by a media creator.

media user—a person or legal entity who purchases media ownership, who licenses media rights from a media rights holder, or a media pirate.

pirate—a person or legal entity who takes or uses media without properly obtaining media rights.

piracy—making, using, selling, displaying, performing, modifying, disclosing, or distributing media without proper authorization.

publisher—a person or legal entity who obtains rights to use certain media and further distribute copies of that media.

### DESCRIPTION OF THE INVENTION

The present invention combines database, Internet, and Web technology with the concepts of the stock market to create a world wide, globally accessible, media exchange. The media exchange allows media creators and media users to come together to exchange media and media rights. Media creators are able to offer their media for sale in the market. Media creators are also able to license various media rights. Those interested in purchasing all the rights to certain media can do so and become the new media rights holder. The system can provide a simple direct way of compensating media rights holders for use of their media. Thus media rights holders are given access through the media exchange to a world-wide market of media users. The system has the potential to reduce piracy and increase the revenue of media rights holders, allowing them to reduce the fees they charge for various licenses. The reduced fees will induce more media users to license the media that they might not otherwise license. The reduced fees would reduce the incentive to pirate media. The global media exchange will offer a wide selection of various media types and will be much more likely to have the media that media users are looking for.

The recent explosion in the use of the Internet as a daily worldwide communications and information search medium for hundreds of millions of people is one of the most significant advanced in the history of the world. It represents a quantum jump in the speed and efficiency with which people find information and communicate.

Digital artists, advertising agencies, business presenters, teachers, students, and home media users need access to a huge media archive that can be searched by classification.

The present invention discloses a media archive containing a comprehensive collection of both stock and fine art, still pictures, clip-art, video, sound effects, sound clips, and music. Copyright holders place their works in the archive and set prices for limited and unlimited, commercial and non-commercial, exclusive and non-exclusive use. Users of the media would agree to a set of terms of use and pay the required fee. The system can be used to collect a license fee and credit the account of the copyright holder. The system of the present invention becomes a clearing-house (auction house) for media. It increases the quality of the media available for its users and create a digital revolution for the distribution of media and compensation for media creators and media rights holders.

The system could take advantage of compression technology to reduce the space required to store the media and to reduce the cost of distributing copies of the media over the network.

The present invention allows media creators and media rights holders to offer their media to a world-wide market. Digital media can be stored in the media archive. Physical media can be referenced by the media archive. Media rights holders can sell (or assign) their rights or can establish different use categories (single use, unlimited personal use, commercial use, use in a publication such as a print add or web site, etc.) and the establish license terms including price for each license option.

The present invention provides a single location where a large collection of media can be searched based on a number of criteria including author, content description, and price. Because of the extent of the collection, a prospective media user is much more likely to find the desired media.

Also, the media user can pay a fair price for the use of the media and the media rights holder can be compensated for each licensed use of his or her creation.

The present invention provides a synergistic community. Artists can be directly and fairly compensated for all use of their creations. Media users know that they can always find something they like and can use at the global media exchange site. The fair compensation and competitive options in a fluid market allows the principles of economics to drive a true market exchange. Like a stock market, the system of the present invention provides a world wide vehicle for establishing the market price for media rights.

Media rights holders can establish an account where sale and license fees can be collected. Media users or buyers can pay for each transaction using credit card online payment system (such as CyberCash or Intellipay) or establish an account that accumulates charges (possibly against a deposit) and settles the account on a regular basis.

Many content creators are also content users and an embodiment of the global media exchange can maintain the account and handle debits and credits.

In a simpler embodiment, the present invention is merely a digital repository with a mechanism for setting a price. In this exemplary embodiment, payment settlement is handled by the parties and the system of the invention facilitates the distribution process.

The system could also include an interface to a duplication service (a duplicator 168) so that physical copies of digital media could be made and delivered to the media users. This would be useful for photographs, art prints, photo CDs, blue prints, music CDs, DVD videos, etc.

The system is also designed to maintain a record of the chain of title to the media rights. As long as an ownership is being tracked by the system, the original owner would be kept in the system as well as any transactions changing ownership.

The system can be used to verify the proper licensing of any media by a user. Various techniques can be used to digitally mark a piece of media with its owners ID or with a transaction code. Software on the users computer could check for valid license codes or dynamically check with the database over the network, to confirm that a license is still valid. Alternatively, the media could be downloaded in a compressed and encrypted form and only unlocked with the proper code. For a single use license, the code would only work once. In another embodiment, licensed media could report back to the system that it is being used and the system could analyze the data to detect piracy problems.

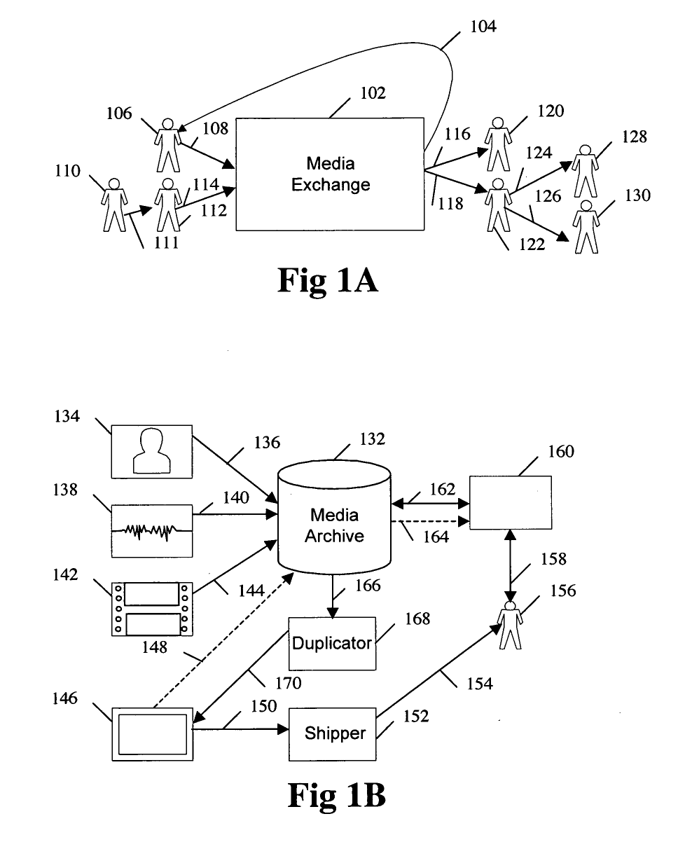

### FIG. 1A

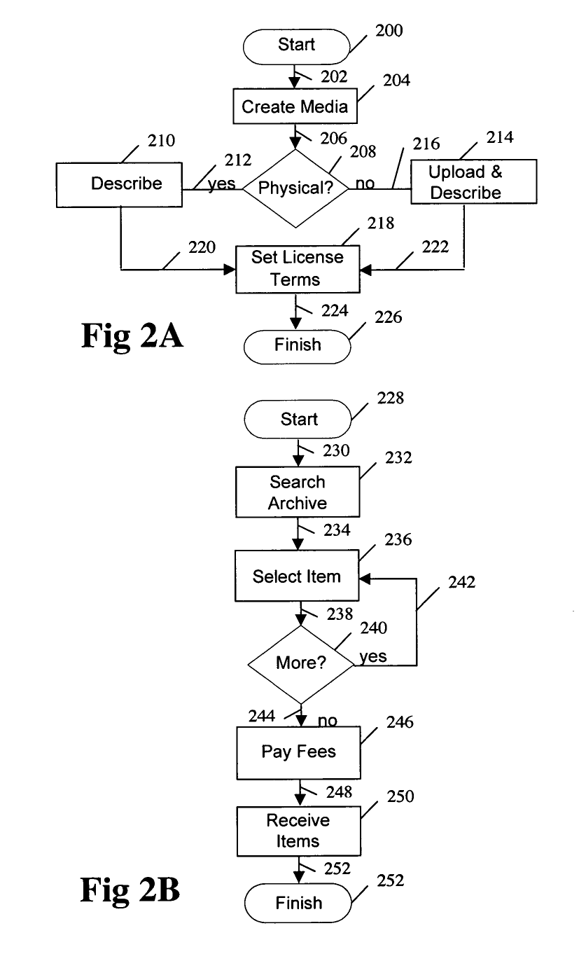

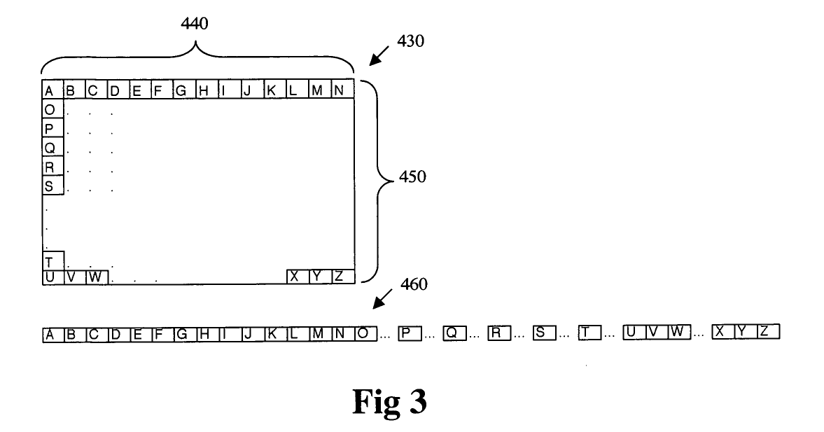

FIG. 1A shows how various people or entities interact with the media exchange 102 of the present invention. A media rights holder 106 can interface directly with the media exchange. Direct interaction includes media submission 108 which includes the steps of uploading the media, describing the media, and setting license terms (see description of FIG. 2A). A media rights holder could be a media creator 110 or a purchaser of media and all of the rights associated with it from a media creator 110. A media creator could also go through an agent 112. As shown in FIG. 1A, a media creator 110 can give the media to the agent 112 and authorize the agent to interact with the media exchange through delegation 111. By delegating rights through an agent, the media creator 110 uses the media exchange 102 indirectly. In this case, the agent uses indirect submission 114 to interact with the media exchange 102 on behalf of the media creator 110 or the current media rights holder 106. For example, a rock star may delegate the submission of his music, photographs, and music videos to his agent or record label.

A media user 120 may interact with the media exchange 102 to search for desired media. Once a piece of media is selected, the media user 120 can choose from a variety of purchase or license options and can pay a fixed price or bid to create a market price. After a price is determined and the fees are paid and confirmed, the system will allow the media user 120 to receive a copy of the desired media for individual use 116. For example, a rock fan can download a rock song for personal use. If a media user 116 wants to use a piece of media in a new form that is distributed to other user, the media user 120 acts as a publisher 122. The publisher 122 licenses the media for publication use 118 and is allowed to further distribute the media to other users. Someone who receives media through such a publication is a publication user 128 and the use is considered a published use 124. The publication user 128 indirectly receives rights to use the media when it is a part of the publication. When another publication user 130 receives the media as part of a publication it is another publication use 126. For example, if a web site designer wants use a picture of a sunset on a web site, the web site designer can license the media for web publication and viewers of the web site can view the pictures. However the web site viewer cannot legally take a permanent copy of the picture without seeking a proper license. Another example of publication use 124 is when a compact disk (CD) publisher licenses a rock song for a “Best of the 70's” album on CD, those who receive a copy of the CD are publication users and don't directly receive the media from the media exchange. However the media rights holder is compensated through the exchange and having passed through the exchange the media on the CD can be identified as being licensed through a particular publisher.

The system of the present invention allows for various types of license, as described above. A media user 120 can obtain a license for unlimited use, time limited use, or single use. In a single use scenario, the media could be streamed using streaming technology, such as Real Networks, Microsoft Windows Media, Apple QuickTime, or my co-pending invention for transmitting video over the Internet. The media exchange 102 would facilitate various license scenarios and download methods.

### FIG. 1B

FIG. 1B illustrates the flow of media through, and user interaction with the media archive 132. A media database serves as a media archive 132. The media archive preferably is an Internet-enabled database repository. The database can either store digital media in the database itself or can reference the media by name or location in a file system or network. The database can also facilitate the exchange of physical media, such as fine art paintings and sculptor, by describing the physical media, by providing a market for exchange of ownership and rights, and by facilitating the shipment of physical media.

FIG. 1B shows three examples of different types of digital media: 1) graphic media 134 could be a digital photograph, digital artwork, scanned image, digital blue print, schematic or similar graphic image; 2) audio media 138 could be any type of digital sound recording, including music, sound effects, vocals, voice recordings or similar audio recording; and 3) video media 142 could be computer animations, digital video, digitized video, or other video containing moving pictures and associated sound tracks. The digital media is transferred to the media archive 132 via graphic submission 136, audio submission 140, or video submission 144, respectively. After digital media is submitted a digital copy is maintained in the media archive 132.

The media archive 132 could be comprised of one or more computer systems that provide digital media storage, information storage in a database, programs that generate forms and process responses, and a network interface to a users computer. The network interface preferably is an Internet connection and a Web server.

The media archive 132 may prepare preview copies of media that are also stored in the archive. Preview copies may be smaller, lower resolution image “thumbnails” of graphics, or short clips of video or audio. The graphic, audio, or video may also be distorted with a watermark or filter so the preview copy is not likely to be pirated.

At the same time the media is submitted, the media rights holder 106 is a system user 156 interacts with the system to describe the media and set purchase and license terms. Any system user 156, whether media creator 110, media rights holder 106, an agent 112, a media user 120, or a publisher 122, uses a user interface 158 on that user's computer 160 to interact with the archive interface 162. The user interface 158 displays various forms for the system user 156 to fill out when interacting with the system.

The forms are preferably Web pages generated by the media archive 132. Good results have been obtained by using the Oracle database and using Java and PL/SQL statements to generate and process the forms. Other means for generating web pages in conjuction with a database are known in the art and include Microsoft SQL/Server, active server pages (ASP) with ODBC, java server pages (JSP) with JDBC, perl scripts with oraperl or ODBC, Cold Fusion, and hundreds of similar combinations.

FIG. 1B also shows physical media 146 being included in the media archive through a physical descriptions 148. Examples of physical media include oil paintings, sculptures, charcoal drawings, audio tapes, compact diskettes, motion picture film, photographs, photographic negatives, hand drawn blue prints, memorabilia, or similar physical pieces of media. Physical media could also include copies of digital media that are created by a duplicator 168. Physical media 146 cannot itself be stored digitally in the media archive 132, so only a reference (via a physical description 148) is stored database of the media archive 132. The system the present invention allows for media rights holders to offer physical media in the media exchange 102 via database information in the media archive 132 in a similar way that digital media is offered. The system can be used to set fixed prices or to determine a dynamic fair market value through bids. Because physical media cannot be received digitally through the archive interface 162, only information representing rights delivery 164 is sent to the user's computer 160.

Additionally, the system of the present invention allows for a system user 156 to purchase a license to copy digital media into a physical form and to order a physical copy of the digital media. A duplication order 166 is sent to the duplicator 168, which creates a piece of physical media 146. Along with the duplication order 166 is information necessary to transfer the media to a shipper 152 (as shown by a transfer to shipper 150). Examples of duplicators are black and white or color printers, photographic printers, poster printers, tape recorders, CD burners, film printers, milling machines, laser cutters, and robotic devices capable of make physical copies based on media data stored in the database. Examples of shippers are the U.S. Postal Service, FedEx, UPS, DHL, bicycle couriers, delivery vans, moving companies, or similar entities that can pickup, transport, and deliver physical media. The systems user 156 (in this case a media user 120) receives the physical media 146 from the shipper 152 as a physical delivery 154.

### FIG. 2A

FIG. 2A shows a flow chart for an embodiment of a submission method of the present invention. The chart begins at an entry point or a submission start 200, continues along a path 202 to a “create media” step 204. Flow continues along a path 206 to a “physical” decision 208. If the “physical” decision 208 is “yes” then flow continues along a physical path 212 to a “describe” step 210 where the system user 156 describes the physical media. Flow continues, along a path 220, to a “set license terms” step 218 where the system user 156 sets up one or more options for purchasing or licensing the media. Flow continues along a path 224 to a submission finish step 226.

However, if the “physical” decision 208 is “no”, flow continues along a path 216 to an “upload and describe” step 214 where a copy of the digital media is transferred to the media archive 132 and the media is described. Flow continues along a path 222 to the” set license terms” step 218, then along the path 224 and ends at the submission finish 226.

### FIG. 2B

FIG. 2B shows a flow chart for an embodiment of a retrieval method of the present invention. The chart begins at a retrieval start 228, continues along a path 230 to a “search archive” step 232 where the system user 156 enters search criteria and conducts searches until a list of matching media items are found. Flow continues along a path 234 to a “select item” step 236 where a media item is selected. The flow continues along a path 238 to a “more” decision 240. If the there is more, then the flow continues along a more path 242 back up to the “select item” step 236. This process continues until the user does not want to select any more items. When the more decision 240 is “no”, then flow continues along a no more path 244 and then reaches a “pay fees” step 246 where fees are paid and confirmed. After the “pay fees” step 246, flow continues along a path 248, hits a “receive items” step 250, where the media, associated rights, and, in some case, the codes to unlock those rights are received. If the media is digital, a copy is transferred to the user. If the media is physical, an order to ship the media is issued to the shipper 152. Then flow continues along a path 252. The flow stops at a retrieval finish 254.

### FIG. 3—Image and Pixel Stream

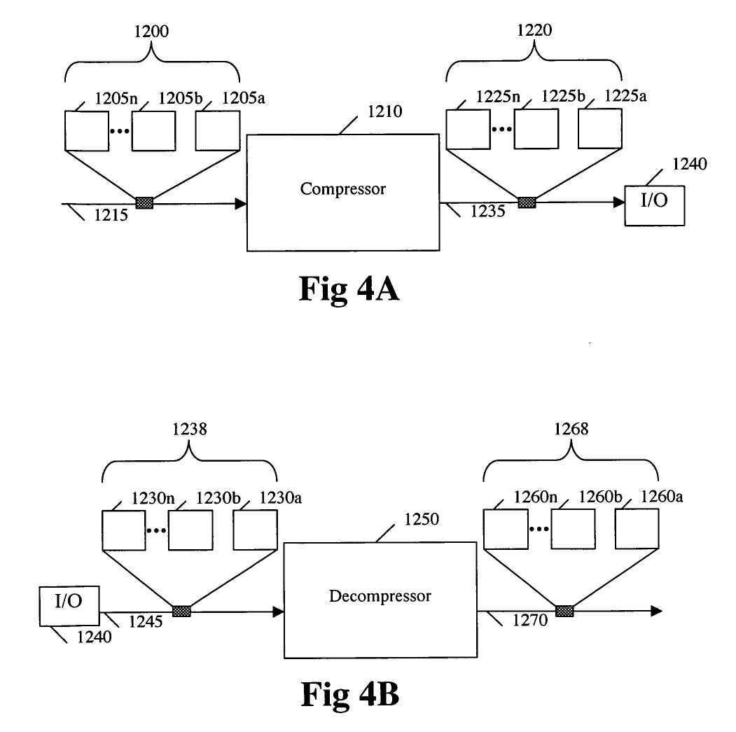

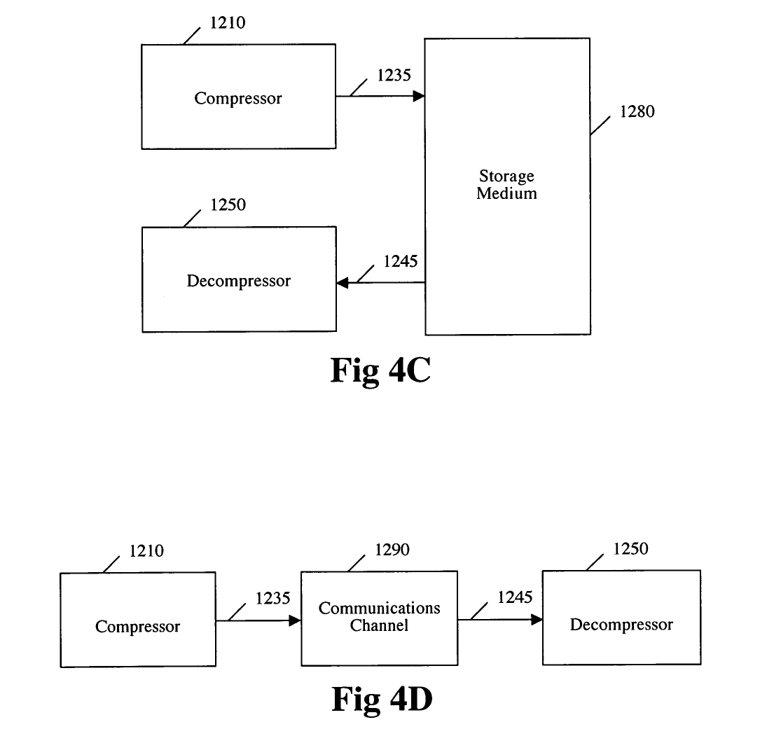

FIG. 3 illustrates an image and its corresponding stream of pixels. A rectangular image 430 is composed of rows and columns of pixels. The image 430 has a width 440 and a height 450, both measured in pixels. In this illustrative embodiment, pixels in a row are accessed from left to right. Rows are accessed from top to bottom. Some pixels in the image are labeled from A to Z. Pixel A is the first pixel and pixel Z is the last pixel. Scanning left to right and top to bottom will produce a pixel stream 460. In the pixel stream 460, pixels A and B are adjacent. Also pixels N and O are adjacent even though they appear on different rows in the image. If adjacent pixels have the same code the process in FIG. 4A will consider them in the same run.

Because the video signal being digitized is analog there will be some loss of information in the analog to digital conversion. The video digitizing hardware can be configured to sample the analog data into the image 430 with almost any width 440 and any height 450. The present invention achieves most of its effective compression by sub-sampling the data image with the width 440 value less than the conventional 640 and the height 450 value less than the convention 480. In a preferred embodiment of the invention, for use in a medical application with T1 Internet transmission bandwidth, image dimensions are sub-sampled at 320 by 240. However an image dimension sub-sampling resolution of 80 by 60 may be suitable for some video application.

FIGS. 4A through 4D—Compression and Decompression Devices

FIGS. 4A and 4B show devices for compressing and decompressing, respectively, a stream video frames.

FIG. 4A shows a video signal 1215 being compressed and encoded by a compressor 1210 to form an encoded data stream 1235, which is sent to an I/O device 1240. The video signal 1215 comprises a series of video frames 1200, shown as first video frame 1205a, second video frame 1205b, . . . through nth video frame 1205n. The encoded data stream 1235 comprises a series of encoded data 1220, shown as first encoded data 1225a, second encoded data 1225b, . . . , through nth encoded data 1225n.

FIG. 4B shows an input encoded data stream 1245 being received from an I/O device 1240, and then, decoded and decompressed by a decompressor 1250 to form a video sequence 1270. The input encoded data stream 1245 comprises received encoded data 1238, shown as first received encoded data 1230a, second received encoded data 1230b, . . . , through nth received encoded data 1230n. The video sequence 1270 comprises a series of decoded video frames 1268, shown as first decoded video frame 1260a, second decoded video frame 1260b, . . . , through nth decoded video frame 1260n.

FIG. 4C shows an embodiment where the I/O device 1240 of FIGS. 4A and 4B is a storage medium 1280. The encoded data stream 1235 from the compressor 1210 is stored in the storage medium 1280. The storage medium 1280 provides the input encoded data stream 1245 as input to the decompressor 1250.

FIG. 4D shows an embodiment where the I/O device 1240 of FIGS. 4A and 4B is a communications channel 1290. The encoded data stream 1235 from the compressor 1210 is transmitted over the communications channel 1290. The communications channel 1290 provides the input encoded data stream 1245 as input to the decompressor 1250.

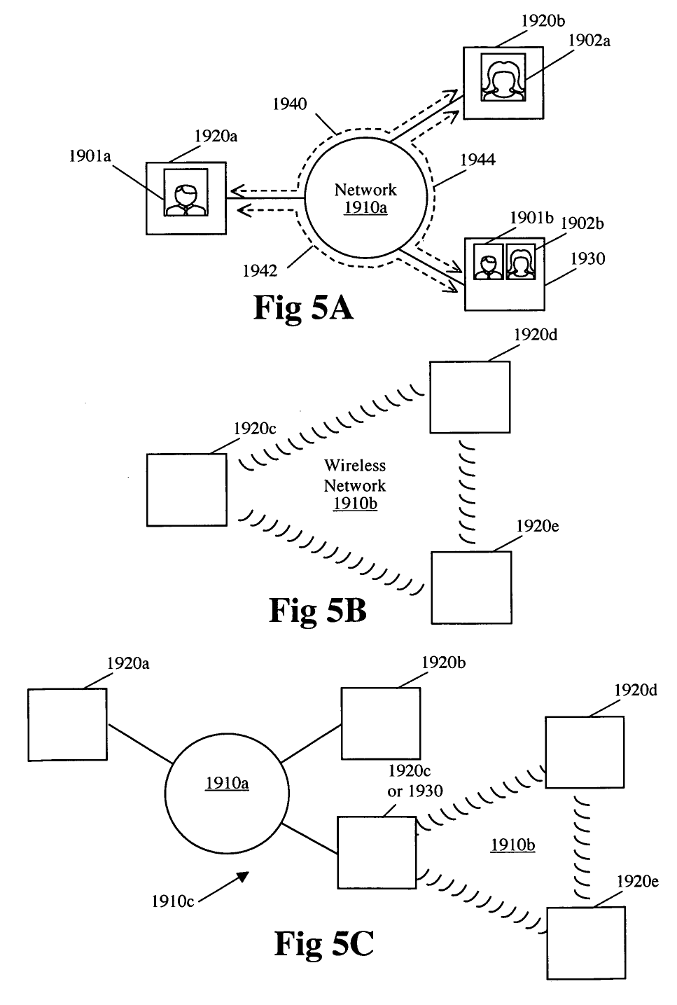

FIGS. 5A through 5C—Handheld Video Transmission Networks

FIGS. 5A through 5C show various network configuration comprising handheld video devices.

FIG. 5A illustrates an exemplary network 1910 comprising a first node 1920a, a second node 1920b, and an optional reflector 1930. The network 1910 is shown as a wired network 1910a. The first node 1920a is displaying a first video 1901a of a man. The second node 1920b is displaying a second video 1902a of a woman. This illustrates a videoconference between the man at the second node 1920b and the woman at the first node 1920a. In the first mode of operation, the respective videos are transmitted over a point-to-point transmission 1940 path between the two nodes over the network 1910. In another mode of operation each of the videos is transmitted to the reflector where both videos are displayed as first reflected video 1901b and second reflected video 1902b. The second video 1902a originates at the first node 1920a is transmitted to the reflector over first indirect path 1942. The second video 1901a originates at the second node 1920b is transmitted to the reflector over second indirect path 1944. The reflector then retransmits the two videos to the respective display nodes, 1920a and 1920b, over the indirect paths. In other configurations, the reflector would also transmit the combined video to other nodes participating in the videoconference.

FIG. 5B shows an example of three nodes, third node 1920c, fourth node 1920d, and fifth node 1920e in a wireless network. The wireless connections are shown as waves. The three nodes operate in the same manner as the three nodes in FIG. 5A.

FIG. 5C shows an example of a combined network 1910c where five nodes are connect in a network comprised of both a wired network 1910a and a wireless network 1910b. Any of the five nodes could transmit video to any of the other nodes in the combined network. Any node, for example third node 1920c as shown, could act as a reflector 1930.

In another embodiment of the present invention, any node could act as a video server and transmit pre-recorded video to one or more other nodes.

These illustrations are exemplary. In practice, combined networks could consist of any number of nodes. Any of the nodes in the network could be a handheld video device.

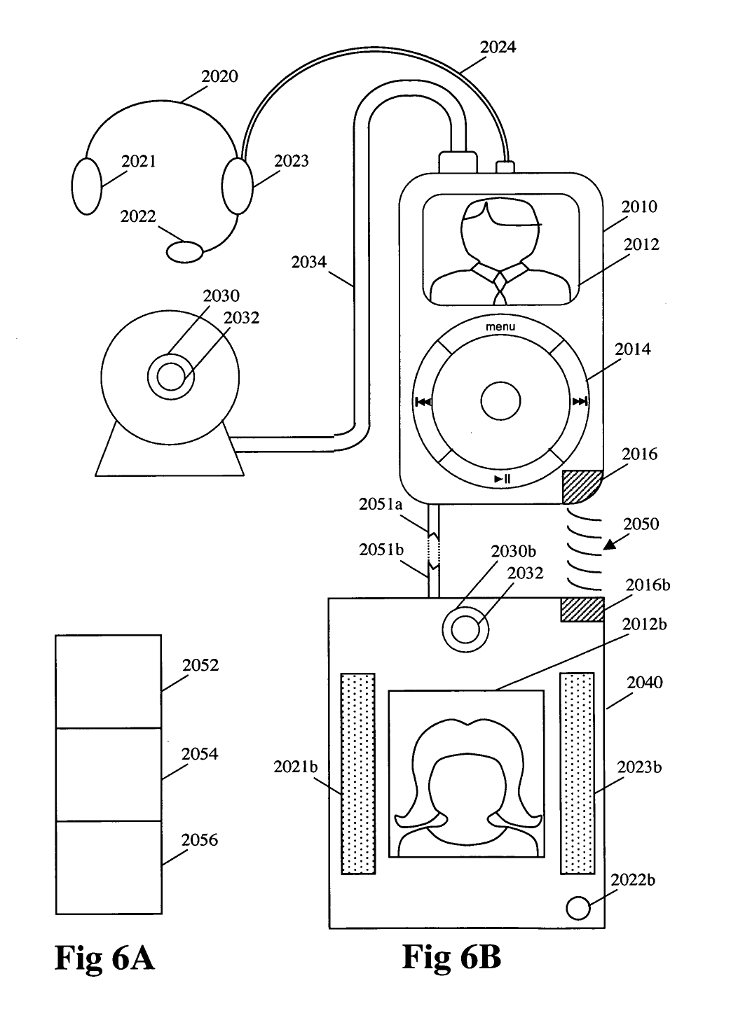

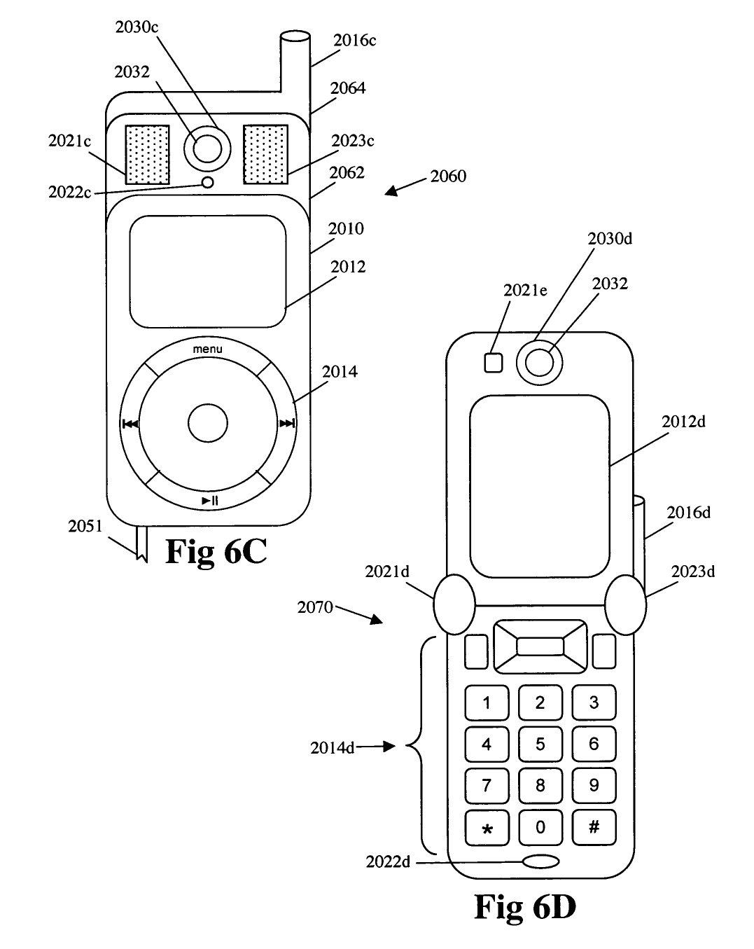

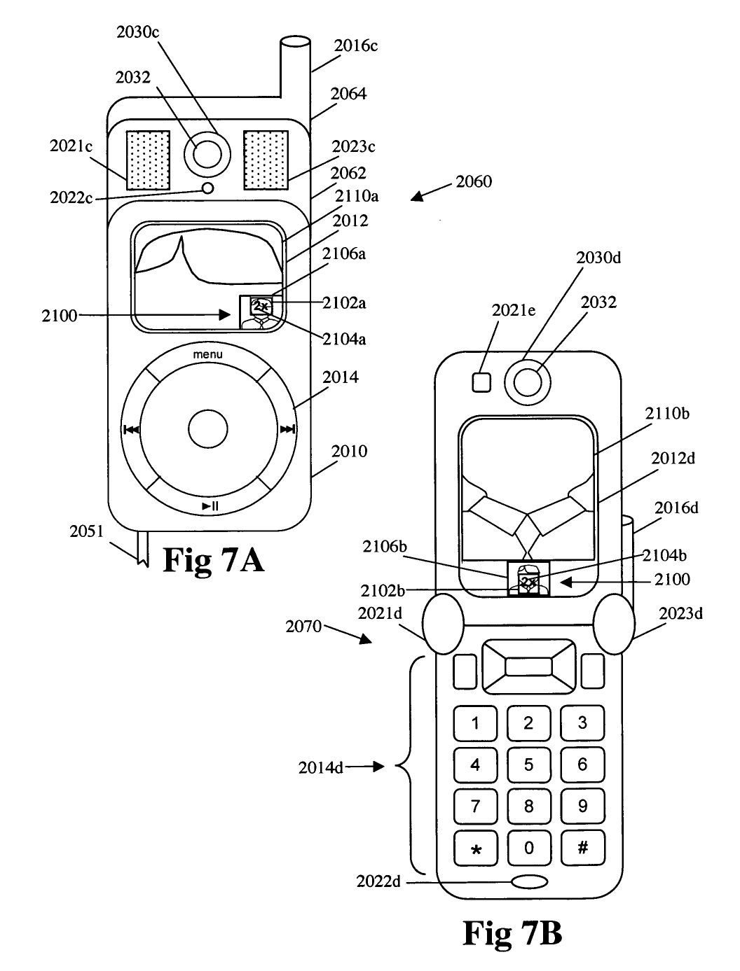

FIGS. 6A through 6D—Handheld Video Devices

FIGS. 6A through 6D show various embodiments of handheld video devices.

FIG. 6A shows a handheld video transmitter comprising a video source 2052, a video transmitter 2054, and video storage 2056.

FIG. 6B shows two handheld video devices in communication over either a wireless connection 2050 or a wired connection 2051.

A first handheld device 2010 comprises a display 2012, manual controls 2014, a wireless port 2016, and a first wired connection 2051a. While either the wireless port 2016 or the wired connection 2051a could be present, only one of the two would be necessary to receive video from or transmit video to other nodes in the network 1910. In this example, the first handheld device is shown as an iPod-type device with an internal hard disk drive. The first handheld device 2010 further comprises a headphone 2020, connected via a speaker/microphone cable 2024, and a camera 2030, connected via a camera cable 2034. The headphone 2020 comprises a right speaker 2021, a microphone 2022, and a left speaker 2023. The camera 2030 has a lens 2032 and internal circuitry that converts the light that passes through the lens 2032 into digital video data.

In the best mode for this embodiment, the iPod-type device is implemented using a standard Apple iPod (enhanced with an audio input for the microphone and, optionally, with a wireless port, and appropriate software), and the camera 2030 is implemented using an iBot Firewire camera manufactured by Orange Micro, a lower performing Connectix USB camera, or similar camera. Alternatively, if the iPod-type device were only used of viewing video, the Apple iPod could be used without hardware modification. In another variation, the microphone could be build into the camera (not shown) instead of the headphones.

A second handheld device 2040 comprises a second display 2012b, a second wireless port 2016b, and a second wired connection 2051b. While either the wireless port 2016b or the wired connection 2051b could be present, only one of the two would be necessary to receive video from or transmit video to other nodes in the network 1910. In this example, the second handheld device is shown as a device with a touch screen. The second handheld device 2040 further comprises a right built-in speaker 2021b, a built-in microphone 2022b, a left built-in speaker 2023b, and a built-in camera 2030b with lens 2032.

The configuration of the second handheld device 2040 has the advantage of eliminating the cables for the external headphone and camera of the first handheld device 2010 by having all elements built-in.

These two devices are exemplary. A two-device handheld videoconferencing network could have two identical handheld devices, such as the first handheld device 2010. Further, a single device with a camera (as shown) could transmit video for display on any number of hand held devices that do not have cameras or microphones.

FIG. 6C illustrates an integrated handheld device 2060 comprising an iPod type device 2010, an A/V module 2062 and an optional wireless module 2064. The iPod type device 2010 comprises display 2012, controls 2014, and a wired connection 2051. The A/V module 2062 comprises a right integrated speaker 2021c, an integrated microphone 2022c, a left integrated speaker 2023c, and a integrated camera 2030c with lens 2032. The A/V module 2062 could be manufactured and marketed separately (as shown) as an add-on module for standard iPods, or could be incorporated into the iPod packaging as an enhanced iPod-type device. The wireless module 2064 comprises an integrated wireless port 2016c. The wireless module 2064 also could be manufactured and marketed separately (as shown) as an add-on module for standard iPods, or could be incorporated into the iPod packaging as an enhanced iPod-type device.

The configuration of the integrated handheld device 2060 has the advantage of eliminating the cables for the external headphone and camera of the first handheld device 2010 by having all elements integrated into removably attached modules that form a single unit when attached. The user can configure the standard iPod based on the user's intended use. If only a wireless connection is needed, only the wireless module 2064 can be attached to the iPod; in this configuration video can be received and displayed but not transmitted. If only video transmission is necessary and a wired connection is convenient, the wireless module 2064 can be omitted. Either configuration provides a single integrated unit that can be carried in the user's pocket and can store and display videos.

FIG. 6D illustrates an cellular integrated device 2070 comprising phone display 2012d, phone controls 2014d (including a number keypad), a cellular port 2016d, a right phone speaker 2021d, a phone earphone 2021e, phone microphone 2022d, left phone speaker 2023d, and a phone camera 2030d with lens 2032.

Any of the handheld devices shown in FIGS. 6A through 6D could be nodes in video transmission networks, such as those shown in FIGS. 4D and 5A through 5C. Each transmitting device preferably would include a compressor 1210 as shown in FIGS. 4A and 4D. Each receiving device preferably would include a decompressor 1250 as shown in FIGS. 4B and 4D. The compressor 1210 and decompressor 1250 preferably would implement one or more embodiments of the compression methods discussed above.

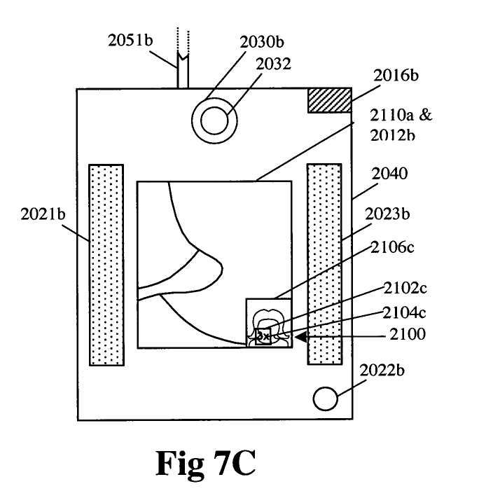

FIGS. 7A through 7C—Handheld Video Devices with Graphical Zoom Control

FIGS. 7A through 7C show exemplary handheld video devices comprising graphical zoom controls.

A graphical user interface (GUI) graphically corresponds to a video display window 2110 through which a single image or a stream of video frames is displayed. The GUI and the video display window 2110 are displayed on a display 2012 (or 2012b or 2012d). The GUI includes a zoom control 2100 having an inner region 2102 positioned within an outer region 2106. The zoom control 2100 is a graphical way for the user of a remote receiver 1610 (see FIGS. 16A and 16B) to send remote control commands to set the parameters of a video transmitter (1600 or 1690) for control the area of the video to be compressed and transmitted.

FIG. 7A shows an embodiment of the iPod-type handheld device 2010 of FIG. 6C displaying a zoom control 2100 having an inner region 2102a positioned within an outer region 2106a. The zoomed video image is show in video display window 2110a. In this embodiment the zoom control 2100 is displayed on top of the video display window 2110a. The size and position of the inner region 2102a relative to the outer region 1206a shows the user which portion of the original video is being received and magnified. Only the selected portion of the original video (in this example, the hair and top of the face) needs to be transmitted in full resolution or high quality. A low resolution, or thumbnail version of the original video frame is optionally displayed in the outer region 2106a. The thumbnail can be updated at a rate slower than the frame rate of the magnified video, such as once or twice a second. The magnification factor 2104a shows the text 2x showing that the portion being displayed in the video display window 2110a is being displayed at twice the size.

FIG. 7B shows an embodiment of the cellular integrated device 2070 of FIG. 6D displaying a zoom control 2100 having an second inner region 2102b positioned within an second outer region 2106b. The zoomed video image is shown in alternate video display window 2110b. In this embodiment, the zoom control 2100 is displayed outside and below the alternate video display window 2110b. The size and position of the second inner region 2102b relative to the second outer region 1206b shows the user which portion of the original video is being received and magnified. Only the selected portion of the original video (in this example, the lower face and tie) needs to be transmitted in full resolution or high quality. A low resolution, or thumbnail version of the original video frame is optionally displayed in the second outer region 2106b. The second magnification factor 2104b shows the text 2x showing that the portion being displayed in the alternate video display window 2110b is being displayed at twice the size.

FIG. 7C shows an embodiment of the second handheld device 2040 of FIG. 6B displaying a zoom control 2100 having an third inner region 2102c positioned within an third outer region 2106c. The zoomed video image is shown in a video display window 2110a shown filling the second display 2112b. In this embodiment, the zoom control 2100 is displayed over the video display window 2110a. The size and position of the third inner region 2102c relative to the third outer region 1206c shows the user which portion of the original video is being received and magnified. Only the selected portion of the original video (in this example, the right shoulder of the woman) needs to be transmitted in full resolution or high quality. A low resolution, or thumbnail version of the original video frame is optionally displayed in the third outer region 2106c. The third magnification factor 2104c shows the text 3x showing that the portion being displayed in the video display window 2110a is being displayed at three times the size. In this embodiment the controls (similar in function to controls 2014) are incorporated into a touch screen of the second display 2012b. The user enters zoom in, zoom out, and pan commands by tapping the third inner region 2102c or the third outer region 2106, or by selecting and dragging the outline of the third inner region 2102c.

### Operation of Graphical Zoom Controls

A user controls aspects and changes parameters of the image displayed within the video display window 2110 using the controls 2014 to enter input commands within the zoom control 2100 by selecting appropriate parts of the controls 2104 (or regions of the zoom control 2100 on a touch screen or with a pointing device). The controls 2014 can be a touch screen, touch pad, iPod-like scroll pad, remote control or other device, depending on the configuration of the handheld device.

The size of the inner region 2102 relative to the outer region 2106 represents the magnification of the portion of the image being displayed within the video display window 2110. A magnification factor 104 representing the current magnification of the image being displayed within the video display window 2110 from the original image is displayed within the inner region 2102. The magnification of the image being displayed is increased by tapping within the inner region 2102, or while in zoom control mode, pressing the “zoom in” button on a iPod-type control 2104 or cell phone control 2014d. As the magnification is thus increased, the size of the inner region 2102 is decreased appropriately relative to the outer region 2106 and the magnification factor 104 is appropriately incremented. The magnification of the image being displayed is decreased by tapping outside of the inner region but inside of the outer region, or while in zoom control mode clicking the “zoom out” button on a iPod-type control 2104 or cell phone control 2014d. As the magnification is thus decreased, the size of the inner region 102 is increased appropriately relative to the outer region 2106 and the magnification factor 104 is appropriately decremented.

The position of the inner region 2102 within the outer region 2106 represents the portion of the entire original image being displayed within the video display window 2110. The portion of the image being displayed within the video display window 2110 is changed by moving the inner region 2102 to the desired position within the outer region 2106 using the touch screen, a pointing device, or the controls 2014 or 2014d. As the position of the inner region 2102 changes within the outer region 2106, the portion of the image displayed within the video display window 2110 changes appropriately.

The display 2012 including the video display window 2110 and a graphical user interface including the zoom control 2100, according to the present invention. The zoom control 2100 of the present invention preferably includes two regions 2102 and 2106. The outer region 2106 forms the outer edge of the zoom control 2100 and represents the entire available original image. The inner region 2102, is included and positioned within the outer region 2106 and represents a region of interest of the original image currently being displayed within the video display window 2110. Within the inner region 2102, a magnification factor 104 is optionally displayed, representing the current magnification being applied to the image displayed within the video display window 2110.

The magnification factor 104 is changed by using the touch screen or controls 2014 (or 2014d) to zoom in or zoom out. By zooming in a number of times, the inner region 102 becomes continually smaller in size and the magnification factor 104 is incremented a number of times equal to the number of times that the control zoomed in.

A user zooms out on a specific portion of the image to decrease the magnification factor 104; the inner region 102 becomes appropriately larger in size and the magnification factor 104 is decremented. By zooming out a number of times, the inner region 102 becomes increasingly larger with each zoom out and the magnification factor 104 is decremented a number of times equal to the number of times the user zooms out, until the magnification factor is equal to 1.

The inner region 2102 also has a pan or positional feature within the outer region 2106, such that the position of the inner region 2102 within the outer region 2106 represents the portion of the entire original image that is being displayed within the video display window 2110. The position of the inner region 2102 is changed within the outer region 2106 by using the touch screen, a pointing device, or controls 2014 to move the inner region 2102 to the desired position within the outer region 2106. Accordingly, the inner region 2102 graphically represents what portion of the entire image is currently being displayed within the video display window 2110 and what magnification factor 104 is currently being used to make this selected portion of the original image fit within the video display window 2110.

### Advantages

### Video Coverage of Remote Events

The present invention will allow low cost, portable, video transmission of events of interest whenever and wherever they happen. These handheld wireless video transmitters will be able to provide news coverage of wars, natural disasters, terrorist attacks, traffic and criminal activities in a way that has never before been possible.

### Improved Continuous Communication

The present invention will enabled enhanced personal communication between friends, family, and co-workers in ways never before possible.

### Improved Entertainment and Education

The present invention will enabled the transmission of video-based entertainment and education in ways never before possible. User will be able to use pocket-sized, handheld device to watch video that are downloaded from a media exchange, streamed from a video server, or transmitted live from a performance, classroom, laboratory, or field experience.

### Improved Healthcare

The present invention would enable a physician or medical specialist to receive medical quality video any time in any location. For example, a critical emergency room ultrasound study could be monitored while it is being performed by less skilled emergency room personnel ensuring that the best medical image is acquired. A rapid diagnosis can be made and the results of a study can be verbally dictated for immediate transcription and use within the hospital.

Further, the present invention could be used to transmit medical quality video from a remote, rural location, including a battle ground. It could also be used to transmit guidance and advice from an expert physician into a remote, rural location.

Thus, the present invention can improve medical care, reduce the turnaround for analysis of medical studies, reduce the turnaround for surgery, and provide medical professionals with continuous access to medical quality imaging.

### Conclusion, Ramification, and Scope

Accordingly, the reader will see that the present invention provides a system and methods of creating a globally accessible media exchange, where media creators, media rights holders, and agents can offer media and media rights to a world-wide market. Media users and publishers can find and preview the media that they need or want and purchase media ownership or license media rights through the exchange. The media exchange can handle both digital media, such as digital graphics, digital audio, or digital video, and physical media. The media exchange can be used to establish a dynamic fair market value for each type of media ownership or license.

Further the present invention provides handheld wireless devices are used to receive and display high quality video. The video can be displayed as it is received live and a graphical zoom control can be used to dynamically control the area of the source image that is to be transmitted in full resolution. In other embodiments, a handheld wireless device captures the video with an attached video camera and microphone and the device transmits the video images live as they are captured. A single handheld wireless video transmitter can transmit to multiple handheld wireless receivers. A plurality of handheld wireless video devices which capture, transmit, receive, and display video over a network are used for mobile video conferencing. In other embodiments the video data is transferred as a video file or streamed from a video server contain pre-recorded video files.

Further the compression and decompression steps of the present invention provides a means of digitally compressing a video signal in real time, communicating the encoded data stream over a transmission channel, and decoding each frame and displaying the decompressed video frames in real time.

Furthermore, the present invention has additional advantages in that it:
1. enables live video transmission and display on pocket-sized handheld devices;
2. enables wireless videoconferencing with portable, handheld video devices;
3. provides an iPod-type device which is able to display high quality color video;
4. provides an iPod-type device which is able to be used as a wireless video transmitter or receiver;
5. enables video coverage of remote events or catastrophic events;
6. improves interpersonal communication, productivity, and effectiveness;
7. improves education;
8. improves entertainment;
9. improves and expands healthcare at lower costs;
10. allows a plurality of prices to be set for different groups of media items in the media archive; and
11. allows a media user to select a desired item of media from a media archive for display on a handheld wireless media receiver;

Although the descriptions above contain many specifics, these should not be construed as limiting the scope of the invention but as merely providing illustrations of some of the preferred embodiments of this invention. For example, the physical layout, cable type, connectors, packaging, and location of the video display or video camera can all be altered without affecting the basic elements of the claimed embodiments. Further, bit ordering can be altered and the same relative operation, relative performance, and relative perceived image quality will result. Also, these processes can each be implemented as a hardware apparatus that will improve the performance significantly.

Thus the scope of the invention should be determined by the appended claims and their legal equivalents, and not solely by the examples given.

I claim:

1. A system for exchanging media, comprising:
a) a plurality of media user devices each used by a plurality of media users, wherein each media user device is configured download media and to perform the downloaded media,
b) a media archive comprising:
i) a media database,
ii) a computer program for generating user forms and interacting with the media database,
iii) a network connection from the media archive to at least one of the user devices,
iv) an archive user interface for displaying said user forms and receiving input from the media users,
c) a network connecting media user devices and the media archive,
wherein a media creator submits a created item of media to a market consisting of the plurality of media users,
wherein each media user search for a desired item of media within a plurality of created items of media, and
whereby the media user can receive the desired item of media.

2. The system of claim 1, wherein at least one of the plurality of media user devices is a handheld receiver.

3. The system of claim 1, wherein at least one of the plurality of media user devices is a handheld video receiver.

4. The system of claim 1, wherein at least one of the plurality of media user devices is a handheld audio receiver.

5. The system of claim 1, wherein at least one of the plurality of media user devices is a handheld wireless receiver and the network is a wireless network.

6. The system of claim 5, wherein the wireless network comprises at least a mobile phone network.

7. The system of claim 5, wherein at least one of the plurality of media user devices is a handheld wireless video receiver.

8. The system of claim 5, wherein at least one of the plurality of media user devices is a handheld wireless audio receiver.

9. The system of claim 7, wherein the handheld wireless video receiver, comprises:
a) a color display having a predetermined display width and display height and having a touch screen for receiving input from a user,
wherein the display width is a predetermined first number of pixels and the display height is a predetermined second number of pixels,
b) an audio output,
c) a program memory, for storing computer programs,
d) a processor, for executing computer programs from the program memory,
e) a data memory, for storing data,
f) a receiver user interface on the touch screen comprising controls for controlling the operation of the handheld wireless video receiver
g) a wireless network interface for connecting to the wireless network via wireless a communications channel, wherein the handheld video receiver maintains connection to the wireless network when being moved from one location to another location or while being freely carried by the user, and
h) a decompressor, cooperating with the processor,
wherein the handheld device has physical dimension allowing it to be held substantially in one hand of the user,
wherein the receiver user interface is operated by one or more fingers of the user,
wherein each of the communications channels from the wireless network to the handheld video receiver has a predetermined bandwidth,
wherein the compressed video frames are received over one of the communications channel,
wherein the decompressor decompresses the compressed video frames,
wherein the compressed video frames is stored in the data memory,
wherein at least a portion of the decompressed video frames is displayed on the color display in real time,
wherein the audio portion plays on the audio output,
whereby user enters commands via the touch screen to play back any of the video frames stored in the data memory, and
whereby the video is displayed while the user carries the handheld wireless video receiver.

10. The system of claim 9, wherein the display of the handheld wireless video receiver displays the forms of the archive user interface on the touch screen, and wherein media user input on the touch screen is transmitted to the media archive user interface.

11. The system of claim 10, wherein the media user selections the video to be played using the touch screen.

12. The system of claim 10, wherein the media user selections the video to be downloaded using the touch screen.

13. The system of claim 9, wherein the controls further comprise mobile telephone controls for entering numeric telephone numbers and for controlling mobile telephone calls.

14. The system of claim 1, wherein the media creator sets a price for a media item in the media archive from a plurality of prices,
wherein each media user agrees to pay the set price, and
wherein upon payment of the set price the media user downloads the media item to the media user device.

15. The system of claim 1, wherein an agent for the media creator sets a price for a media item in the media archive from a plurality of prices,
wherein each media user agrees to pay the set price, and
wherein upon payment of the set price the media user downloads the media item to the media user device.

16. The system of claim 15, wherein a first group of media items in the media archive have a first set price, and
wherein a second group of media items in the media archive have a second set price,
whereby a different price is paid for an item from the first group of media items than for an item from the second group of media items.

17. The system of claim 16, wherein the first set price and the second set price is determined by respective market demand for the first group of media items and the second group of media items.

18. The system of claim 1, wherein one of media users dynamically bids for a desired media item from the media archive, and
wherein the bid is accepted by the media rights owner or an agent for the media rights owner,
whereby a price for the desired media item is set.

19. The system of claim 1, further comprising a handheld video transmitter,
wherein the handheld video transmitter is connected to the network,
whereby audio and video is uploaded from the transmitter to the media archive.

20. A method for retrieving media from a media exchange using a handheld media receiver comprising the steps of:
a) searching a media archive for a desired item of media,
b) selecting the desired item of media from a list displayed on the display of the handheld media receiver,
c) receiving the desired item of media on the handheld media receiver.
